(19) United States
(12) Patent Application Publication
(10) Pub. No.: US 2018/0273276 A1
(43) Pub. Date: Sep. 27, 2018

(54) ANTIMICROBIAL COMPOSITION COMPRISING CITRAL, HEXANAL AND LINALOOL AS ACTIVE INGREDIENTS AND APPLICATION IN PACKAGING MINIMALLY PROCESSED FRUITS OR VEGETABLES

(71) Applicant: INSTITUTO TECNOLÓGICO DEL EMBALAJE, TRANSPORTE Y LOGÍSTICA, Paterna (ES)

(72) Inventors: Marta Inés LARA LLEDÓ, Paterna (ES); Maria de la Paz BALAGUER GRIMALDO, Paterna (ES); Ana BELTRÁN SANAHUJA, Paterna (ES); Carmen SANCHEZ REIG, Paterna (ES); Laura ZACARÉS SANMARTÍN, Paterna (ES); Susana AUCEJO ROMERO, Paterna (ES)

(73) Assignee: INSTITUTO TECNOLÓGICO DEL EMBALAJE, TRANSPORTE Y LOGÍSTICA, Paterna (ES)

(21) Appl. No.: 15/764,212

(22) PCT Filed: Sep. 29, 2016
(86) PCT No.: PCT/EP2016/073225

§ 371 Date: Mar. 28, 2018

(30) Foreign Application Priority Data
Sep. 30, 2015 (EP) 15382475.0

(51) Int. Cl. B65D 81/28; A01N 35/02; A01N 31/02; C08K 5/07; C08K 5/05; A01N 25/10; C09D 5/14; C09D 7/63; A01N 25/34; A01N 37/10; A01N 37/06; B65D 65/42; A23B 7/154; A23L 3/3499; A23L 3/349

(52) U.S. Cl. CPC B65D 81/28; A23V 2002/00; A01N 31/02; C08K 5/07; C08K 5/05; A01N 25/10; C09D 5/14; C09D 7/63; A01N 25/34; A01N 37/10; A01N 37/06; B65D 65/42; A23B 7/154; A23L 3/3499; A23L 3/349; A01N 35/02

(57) ABSTRACT

It is provided an antimicrobial combination for the preservation of foodstuff, comprising citral, hexanal, and linalool as the only active ingredients having antimicrobial activity, and optionally other components and/or excipients devoid of any antimicrobial activity, an active packaging material for the preservation of foodstuff comprising the mentioned antimicrobial combination, as well as an active package comprising the active packaging material. The packaging material is useful for the preservation of foodstuff, particularly of minimally processed fruits or vegetables. Also, it is provided a process for producing the packaging material.

The present invention relates to compositions having antimicrobial properties to be used in active packaging for foodstuff, particularity for minimally processed fruits or vegetables. The invention also relates to an active package comprising the mentioned compositions.

### BACKGROUND ART

The demand of minimally processed fruits or vegetables has substantially risen over the last few years. However, minimally processed fruits or vegetables are more perishable than whole fruits or vegetables, mainly due to the presence of cut unprotected surfaces and damaged plant tissues, and the minimal processing required. Damage of tissues allows the growth of some species of yeasts such as Saccharomyces cerevisiae and moulds such as Aspergillus niger and Penicillium aurantiogriseum, among others, as well as of some bacteria. The short shelf life and quality loss of these products is nowadays a serious problem since this rapid expiration makes very difficult their marketing and export.

In order to extend shelf life of minimally processed fruits or vegetables, several strategies, usually combined, can be implemented. Among them, the use of low temperatures during their storage and distribution, hygienic practices, use of antimicrobial agents, edible coatings and preservation under modified atmospheres are the most used. Nevertheless, none of these techniques provides a definitive solution to fresh cut fruits or vegetables, providing only slight increases in their shelf life.

One of the most widely spread strategies is the use of freshness-enhancing products and compositions in the packaging processes and materials.

The technologies involved in incorporating active ingredients in the packaging materials are overall known as “active packaging”.

Generally speaking, the main goal of active packaging is to maintain product quality and to extend shelf life by incorporating components with certain chemical and biological activities in the packaging materials, that produce a positive interaction with the packed foodstuff. These active components can either be: i) coated or impregnated on the packaging materials; ii) incorporated (interspersed) into them or iii) immobilized on their surfaces. In the first two cases, the components could migrate from the packaging material to the packaged food where they carry out their beneficial effects, whereas in the third, the components do not migrate and cause their effect even though they remain bound to the package.

Additionally, in response to the consumer pressure to reduce chemically synthesized additives in foods, the interest in the use of natural substances to prevent foodstuff, particularly fresh peeled and/or cut fruits or vegetables, from microbiological spoilage while assuring safety and maintaining the organoleptic characteristics of the product has significantly increased in the last years. (cf. R. C. Soliva-Fortuny, et al. “New advances in extending the shelf-life of fresh-cut fruits: a review” Trends in Food Science & Technology, 2003, Vol. 14, pp. 341-353). Particularly, individual volatile active constituents of plant essential oils have been studied for their antimicrobial activity against many microorganisms, including several pathogens.

In V. Muriel-Galet et al., “Development of antimicrobial films for microbiological control of packaged salad”, International Journal of Food Microbiology, 2012; Vol. 157. pp. 195-201, an active packaging for minimally processed salads with PP/EVOH films containing citral demonstrated antimicrobial activity against spoilage flora and pathogens Escherichia coli, Salmonella enterica, and Listeria monocytogenes in contaminated salads.

Lanciotti et al. “Effect of Hexanal on the Shelf Life of Fresh Apple Slices”, J. Agric. Food Chem. 1999, Vol. 47, pp. 4769-4776 discloses that the addition of hexanal at levels not exceeding 100 ppm in the storage atmosphere of fresh sliced apples had an important effect on their quality. The hexanal is not incorporated in the packaged film.

P. Suppakul et al. “Efficacy of polyethylene-based antimicrobial films containing principal constituents of basil”, LWT—Food Science and Technology, 2008, Vol. 41, pp. 779-788, discloses a low-density polyethylene (LDPE)-based films containing linalool as antimicrobial packages to retard microbial growth on food surfaces, particularly on cheddar cheese. No mention is made to its possible effect in the preservation of fresh-cut fruit.

However, their practical application in fruits and vegetables could somehow be limited due to their strong impact and the organoleptic changes they can cause in food products. Therefore, essential oils or their pure compounds at concentration compatibles with sensorial features of fruits and vegetables could be able to significantly prolong the shelf life of minimally processed fruits without altering their sensory properties.

Therefore, there is a need in the art to find new compositions with higher antimicrobial potencies to improve the current active packaging materials. These new compositions should be able to slow down the deterioration of packaged foodstuff due to the presence of microorganisms, thus helping to preserve its nutritional composition, its colour and its organoleptic properties. Particularly, despite the large number of possible ways to treat fresh-cut fruits and vegetables taught by the prior art, the provision of packages allowing to extend the shelf life of minimally processed fruits or vegetables without a significant modification of their sensorial properties remain an active field of research.

### SUMMARY OF THE INVENTION

The present inventors, in an attempt for developing an improved active packaging, have found a combination of components that provides an unexpected effect against some species of yeasts such as Saccharomyces cerevisiae and moulds such as Aspergillus niger and Penicillium aurantiogriseum. Additionally, the incorporation of such a combination in an active packaging has an improved effect on the preservation of foodstuff, particularly of minimally processed fruits and vegetables, more particularly of fresh peeled and/or cut fruits or vegetables.

Although it is known the effect of citral, hexanal and linalool on several microorganisms and/or the preservation of some foodstuff, their combined use, and particularly their incorporation into a packaging material to manufacture an active packaging, has not been disclosed. Inventors have surprisingly found that the combination of citral, hexanal, and linalool, particularly in a package, has an improved effect on the preservation of foodstuff, particularly of minimally processed fruits and vegetables, more particularly of fresh peeled and/or cut fruits or vegetables. This effect is higher than the sum of effects of citral, hexanal, and linalool, separately. Thus, the combination of citral, hexanal, and linalool provides a synergic effect on the preservation of foodstuff, particularly of minimally processed fruits and vegetables.

Thus, a first aspect of the invention relates to an antimicrobial combination for the preservation of foodstuff, comprising citral, hexanal, and linalool as the only active ingredients having antimicrobial activity, and optionally other components and/or excipients devoid of any antimicrobial activity.

The potency of this antimicrobial combination guarantees that smaller amounts of the antimicrobial compound mixture can be used in active packaging materials, which ensures: i) the active packaging materials are more convenient in terms of overall manufacturing costs; ii) the accumulation of volatile compounds in the packaged food is minimized; thus potential undesirable flavours are also minimized, as the effective antimicrobial concentration used in the films is lower due to their synergistic antimicrobial activity.

A second aspect of the invention relates to an active formulation for foodstuff packaging comprising a polymeric matrix and the antimicrobial combination as defined above.

A third aspect of the invention relates to an active packaging material for the preservation of foodstuff, comprising the active formulation as defined above.

A fourth aspect of the invention relates to a process for the preparation of the packaging material as defined above, wherein the process comprises i) melt mixing a polymeric matrix and the active agents citral, hexanal, and linalool to obtain the active formulation as defined above; and ii) processing the active formulation obtained in step i) through either extrusion or injection to provide a single or multilayer structure, in order to obtain a packaging material comprising a polymeric matrix and citral, hexanal, and linalool.

A fifth aspect of the invention relates to a process for preparing the packaging material of the third aspect of the invention, comprising the steps of:
a) optionally, applying to the surface of a substrate to be coated with the active formulation a surface treatment technique to improve interaction with the substrate, such as corona treatment;
b) preparing an active formulation in the form of a solution by dissolving a polymeric matrix in at least one suitable solvent; optionally, incorporating at least one plasticiser; optionally, incorporating at least one anti-fog compound; and incorporating the antimicrobial combination of the invention;
c) applying the active formulation of the invention to the substrate by coating, printing, dipping, or spraying; and
d) drying the layer comprising the active formulation.

Another aspect of the invention relates to the use of the packaging material as defined above for the preservation of foodstuff, particularly of minimally processed fruits and vegetables, more particularly of fresh peeled and/or cut fruits or vegetables.

The use of a packaging material comprising the three active agents mentioned above allows extending the shelf life of foodstuff without a significant modification of its organoleptic properties. Particularly, shelf life of minimally processed fruits and vegetables, particularly fresh peeled and/or cut fruits or vegetables, can be increased in 2 to 5 days of storage regarding their current shelf life.

Another aspect of the invention relates to an active package comprising the packaging material as defined above.

It also forms part of the invention a method for the preservation of minimally processed fruits and vegetables, more particularly of fresh peeled and/or cut fruits or vegetables comprising the packaging of fresh foodstuff with the active package defined above.

### BRIEF DESCRIPTION OF THE DRAWINGS

FIG. 1 shows sensory evaluation of pineapple packed with control (PP80) and active film (PP10/70a_8.5% CHL) of Example 13 stored at 4° C. for 7 days followed by 5 days at 8° C. 5=very good; 4=good; 3=fair (limit of marketability); 2=poor; 1=bad (unusable).

FIG. 2 shows sensory evaluation of orange packed with control (PP80) and active film (PP10/70a_8.5% CHL) of Example 13 stored at 4° C. for 7 days followed by 5 days at 8° C. 5=very good; 4=good; 3=fair (limit of marketability); 2=poor; 1=bad (unusable).

FIG. 3 shows sensory evaluation of pineapple packed with control (PP/PP:10% EVA) and active tray (PP/PP:10% EVA:20% PS_SB) of Example 16 stored at 4° C. for 7 days followed by 3 days at 8° C. (5=very good; 4=good; 3=fair (limit of marketability); 2=poor; 1=bad (unusable)).

FIG. 4 shows sensory evaluation of orange packed with control (PP/PP:10% EVA) and active tray (PP/PP:10% EVA:20% PS_SB) of Example 16 stored at 4° C. for 7 days followed by 3 days at 8° C. (5=very good; 4=good; 3=fair (limit of marketability); 2=poor; 1=bad (unusable)).

FIG. 5 shows sensory evaluation of pineapple packed with control and packaging system of Example 17 stored at 4° C. for 7 days followed by 5 days at 8° C. 5=very good; 4=good; 3=fair (limit of marketability); 2=poor; 1=bad (unusable).

FIG. 6 shows sensory evaluation of orange packed with control and packaging system of Example 17 stored at 4° C. for 7 days followed by 5 days at 8° C. 5=very good; 4=good; 3=fair (limit of marketability); 2=poor; 1=bad (unusable).

### DETAILED DESCRIPTION OF THE INVENTION

All terms as used herein in this application, unless otherwise stated, shall be understood in their ordinary meaning as known in the art. Other more specific definitions terms as used in the present application are as set forth below and are intended to apply uniformly throughout the specification and claims unless an otherwise expressly set out definition provides a broader definition.

The term “minimally processed fruits or vegetables” refers to any type of fruit and vegetable that has been physically altered from its original state (e.g. trimmed, peeled, washed, cut, or sliced), but remains in a fresh, unprocessed state. These products reach the consumer in a ready to eat (RTE) form (namely as a 100% edible product) allowing direct consumption without previous preparation or transformation.

The term “antimicrobial combination” as used herein refers to a combination of chemical compounds (a chemical composition) that inhibit the growth or kill any microbial organism such as bacteria, molds, yeasts, and any other microorganism that can contaminate and deteriorate packaged foodstuff. With regard to the biological activity against bacteria, the antimicrobial compounds forming the combination can be bacteriostatic and/or bactericidal. With regard to the biological activity against fungi, i.e. molds and yeasts, the antimicrobial compounds forming the combination can be fungistatic and/or fungicidal.

The term “optionally comprising other components and/or excipients devoid of any antimicrobial activity” as used herein refers to the fact that the antimicrobial combination of the invention can have added components which are not endowed of antimicrobial activity themselves, but which boost the antimicrobial activity of the combination.

The term “safe and effective amount” of the antimicrobial combination is defined as an amount sufficient to significantly provide the required effect on the preservation of foodstuff without substantial variation of its organoleptic properties.

The term “structural layer”, as used herein, relates either to a support over which the layer comprising the active formulation of the invention (active layer) is applied, or to a layer formed by coextrusion or coinjection together with the active layer.

The term “interspersed in the polymeric matrix”, as used herein, means that the compounds to which it relates (namely citral, hexanal and linalool) are at least in part distributed and scattered inside the polymeric matrix, so that they are released in a controlled manner to the cavity where the packaged food is kept.

The term “corona treatment” as used herein refers to a surface modification technique that uses low temperature corona discharge plasma to impart changes in the properties of a surface, in this case the surface of a packaging material.

The term “solvent suitable for food contact” as used herein refers to any solvent that can be used safely in the manufacture of plastics and other materials which come into contact with food for human consumption. The solvent must be harmless and devoid of any toxic properties.

The term “plasticiser” as used herein refers to a product that allows the adhesion of the active formulation to a substrate, and that makes the polymer less brittle, enhancing the flexibility and mobility of the polymeric chain. A list of plasticisers suitable for carrying out the invention follows: phthalate-based plasticizers, adipate-based plasticizers, benzoates, terephthalates, epoxidized vegetable oils, alkyl sulphonic acid phenyl ester (ASE), sulfonamides, organophosphates and glycols/polyethers. Among these, preferred plasticisers are tert-butyl citrate, polyadipate or glycerol.

The term “antifog” as used herein refers to chemicals that prevent the condensation of water in the form of small droplets on a surface. A list of antifog agents suitable for carrying out the invention follows: Non-ionic surfactants like polyhydric alcohol fatty acid esters, higher fatty acid amines, higher fatty acid amides, polyoxyethylene ethers of higher fatty alcohols, polyoxyethylene glycols of higher fatty acids and ethylene oxide adducts of higher fatty acid, amines, or amides and their admixtures are meant. Among these, preferred antifog agents are polyhydric alcohol fatty acid esters, especially sorbitan derivatives, polyoxyethylene glycols of higher fatty acids and glycerin fatty acid esters and their admixtures.

The term “active formulation” as used herein refers to the result of combining the antimicrobial composition of the invention with a polymeric matrix.

The term “wt. %” or “percentage by weight”, as used herein, of a component, as used herein, means the amount of the single component relative to the total weight of the composition or, if specifically mentioned, of other component. The term “w/w” designates weight/weight.

As stated above, a first aspect of the invention relates to an antimicrobial combination of citral, hexanal, and linalool for the preservation of foodstuff, particularly of minimally processed fruits and vegetables, more particularly of fresh peeled and/or cut fruits or vegetables. The composition comprises citral, hexanal, and linalool as the only active ingredients having antimicrobial activity, and optionally other components and/or excipients devoid of any antimicrobial activity.

In a particular embodiment, in the antimicrobial combination of the invention the amount of each one of the active agents (i.e. citral, hexanal and linalool) is from 1 to 90 wt. %, from 5 to 90 wt. %, from 15 to 75 wt. %, from 1 to 50 wt. %, or from 25 to 60 wt. %, with respect to the total amount of citral, hexanal, and linalool. Even more particularly, the amount of citral is 33.3 wt %, the amount of hexanal is 33.3 wt. % and the amount of linalool is 33.3 wt. %, with respect to the total amount of the three active agents. Particularly, the amount of citral, hexanal, and linalool are in a safe and effective amount to provide an antimicrobial effect.

As commented above, the second aspect of the invention relates to an active formulation for foodstuff packaging comprising a polymeric matrix and the antimicrobial combination defined above. The amount of the antimicrobial combination is the one needed to get an active formulation, namely a safe and effective amount to achieve the sought antimicrobial effect.

In a particular embodiment, optionally in combination with one or more features of the particular embodiments defined above or below, the polymeric matrix is selected from the group consisting of a polyethylene terephthalate (PET), a polyethylene (PE), a polilactic acid matrix (PLA), polystyrene matrix (PS), ethylene vinyl acetate (EVA), polyamide, and a polypropylene (PP) matrix. Particularly, the polymeric matrix is a polypropylene matrix.

In another particular embodiment, optionally in combination with one or more features of the particular embodiments defined above or below, the antimicrobial combination of citral, hexanal, and linalool is interspersed in the polymeric matrix.

In another particular embodiment, optionally in combination with one or more features of the particular embodiments defined above or below, the active formulation of the invention is to be processed by injection or extrusion techniques and the amount of the antimicrobial combination of citral, hexanal, and linalool as defined above is from 0.5 to 10 wt. %, or from 2 to 8.5 wt. %, or from 3 to 6 wt. %, with respect to the total amount of citral, hexanal, linalool, and polymeric matrix. In a more particular embodiment, the active formulation, when applied to the packaging material, is forming a layer with a thickness from 5 to 100 μm, or from 10 to 80, or from 20 to 50 μm, and more particularly 40 or 70 μm.

In another particular embodiment of the active formulation of the invention, optionally in combination with one or more features of the particular embodiments defined above or below, the active formulation of the invention is to be used as a coating and the amount of the antimicrobial combination of citral, hexanal, and linalool as defined above is from 10 to 40 wt. %, particularly from 15 to 30 wt. %, with respect to the polymeric matrix. In a more particular embodiment, the active formulation, when applied to the packaging material is forming a coating layer with a thickness from 1 to 10 μm, or from 4 to 9 μm, or from 5 to 6 μm, particularly of 3 μm.

It also forms part of the invention a process for preparing the active formulation of the invention, comprising:
a) providing a polymeric matrix and, optionally, dissolving the polymeric matrix in at least one suitable solvent;
b) optionally, incorporating at least one plasticiser;
c) optionally, incorporating at least one anti-fog compound; and
d) incorporating the antimicrobial combination of the first aspect of the invention.

In a particular embodiment of this aspect of the invention, the polymeric matrix is previously melted before incorporating the antimicrobial combination of the invention. The obtained molten composition can be directly processed to provide a packaging material, particularly by injection or extrusion techniques, or processed to obtain an active formulation in form of pellets. These pellets can be subsequently used to prepare the packaging material of the invention, for instance injection or extrusion techniques.

In another particular embodiment, optionally in combination with one or more features of the particular embodiments defined above or below, in step a) the polymeric matrix is dissolved in at least one suitable solvent. The suitable solvent is a solvent suitable for food contact.

In a particular embodiment of this aspect of the invention, optionally in combination with one or more features of the particular embodiments defined above or below, in step b) at least one plasticiser is incorporated. Particularly, the at least one plasticiser is tert-butyl citrate, polyadipate or glycerol.

In a particular embodiment of this aspect of the invention, optionally in combination with one or more features of the particular embodiments defined above or below, in step c) at least one anti-fog compound is incorporated.

Particularly, the at least one anti-fog compound is sodium lauryl sulphate, glycerol or an ethoxy-amine.

As commented above, the third aspect of the invention relates to a packaging material for the preservation of foodstuff, particularly of minimally processed fruits and vegetables, more particularly of fresh peeled and/or cut fruits or vegetables, comprising the active formulation as defined above.

In a particular embodiment, optionally in combination with one or more features of the particular embodiments defined above or below, the packaging material comprises a structural layer and a layer comprising the active formulation as defined above, namely comprising a polymeric matrix and a safe and effective amount of the antimicrobial combination of citral, hexanal, and linalool as defined above.

The structural layer can be a polymer selected from a polyethylene terephthalate (PET), a polyethylene (PE), a polilactic acid matrix (PLA), polystyrene matrix (PS), ethylene vinyl acetate (EVA), polyamide, and a polypropylene (PP). In a particular embodiment, optionally in combination with one or more features of the particular embodiments defined above or below, the structural layer is polypropylene (PP).

In another particular embodiment, optionally in combination with one or more features of the particular embodiments defined above or below, the polymeric matrix of the active formulation is formed by the same polymer as the structural layer, the polymeric matrix allowing the sustained release of the volatile active agents.

As mentioned above, a fifth aspect of the invention relates to a process for the preparation of the packaging material as defined above, wherein the process comprises i) melt mixing a polymeric matrix and the active agents citral, hexanal, and linalool to obtain the active formulation as defined above; and ii) processing the active formulation obtained in step i) through either extrusion or injection to provide a single or multilayer structure, in order to obtain a packaging material comprising a polymeric matrix and citral, hexanal, and linalool.

In a particular embodiment, optionally in combination with one or more features of the particular embodiments defined above or below, alternatively, in the process above, step ii) can be carried out by submitting the active formulation to coextrusion or coinjection with at least one polymer, which can be the same as or different to the polymer in the active formulation, in order to obtain a structure of at least two layers comprising a structural layer and a layer of the active formulation as defined above.

In a particular embodiment, the polymer forming the structural layer is polyethylene (PE) and polypropylene (PP), particularly polypropylene. The structural layer can be a polymer selected from a polyethylene terephthalate (PET), a polyethylene (PE), a polilactic acid matrix (PLA), polystyrene matrix (PS), ethylene vinyl acetate (EVA), polyamide, and a polypropylene (PP).

As commented above, it also forms part of the invention a process for preparing the packaging material of the third aspect of the invention, comprising the steps of:
a) optionally, submitting the surface of a substrate to be coated with the active formulation to a corona treatment;
b) preparing an active formulation in the form of a solution by dissolving a polymeric matrix in at least one suitable solvent; optionally, incorporating at least one plasticiser; optionally, incorporating at least one anti-fog compound; and incorporating the antimicrobial combination of the invention;
c) applying the active formulation of the invention to the substrate by coating, impression, dipping, or spraying; and
d) drying the layer comprising the active formulation.

In a particular embodiment of this aspect of the invention, in step b), the coating process comprises roller printing, flexography, ink jet printing, or rotogravure.

In a particular embodiment of this aspect of the invention, the formulation is deposited on the whole surface of the substrate, or alternatively, only on some areas of the surface of the substrate.

In another particular embodiment, the deposition can follow certain patterns, which might be regular or irregular.

It is also part of the invention a packaging material obtainable by the process described above, including any of the particular embodiments mentioned above or below.

In a particular embodiment of the packaging material of the invention, optionally in combination with one or more features of the particular embodiments defined above or below, the thickness of the coating layer in the packaging material as defined above is from 1 to 10 μm, or 4 to 9 μm, or 5 to 6 μm, particularly 3 μm.

In another particular embodiment of the packaging material of the invention, optionally in combination with one or more features of the particular embodiments defined above or below, the thickness of the extruded layer in the packaging material as defined above is from 5 to 100 μm, or from 10 to 80, or from 20 to 50 μm, and more particularly 40 or 70 μm.

In a particular embodiment, optionally in combination with one or more features of the particular embodiments defined above or below, the packaging material of the invention is a lid, a tray, a film, a paper, a bag, a label or a pad.

As stated above, another aspect of the invention relates to an active package comprising the packaging material as defined above.

In a particular embodiment, optionally in combination with one or more features of the particular embodiments defined above or below, the active package of the invention can be prepared by a process comprising the steps of:
a) submitting the surface of a package to be coated with the active coating of the invention to a corona treatment;
b) applying the active coating of the invention to the package by lamination, impression or spraying; and
c) drying the layer comprising the active formulation.

In a more particular embodiment, optionally in combination with one or more features of the particular embodiments defined above or below, the process for preparing the food package further comprises first preparing the active formulation of the invention, which will be used as a coating, by a process comprising:
a) dissolving a polymeric matrix as defined above in at least one solvent suitable for food contact;
b) incorporating at least one plasticiser;
c) incorporating at least one anti-fog compound; and
d) incorporating the antimicrobial combination of the first aspect of the invention.

It is also part of the invention an active package coated with the active coating of the invention, obtainable by the process described above, including any of the particular embodiments abovementioned.

The active package of the invention can be of any type, either flexible, rigid, or both, and in any form or size, such as trays, boxes, tags, pads or films.

In a particular embodiment, optionally in combination with one or more features of the particular embodiments defined above or below, the active package of the invention comprises (1) a packaging material as defined above, particularly a lid, and (2) a tray comprising a layer comprising potassium sorbate and sodium benzoate.

In another particular embodiment, optionally in combination with one or more features of the particular embodiments defined above or below, the layer of the tray comprising potassium sorbate and sodium benzoate further comprises an at least one anti-fog compound. Particularly, the at least one anti-fog compound can be sodium lauryl sulphate, glycerol or an ethoxy-amine.

In a particular embodiment, optionally in combination with one or more features of the particular embodiments defined above or below, the active package of the invention comprises two pieces, such as a tray and a lid. Optionally, the lid can be built-in with the tray forming a single piece.

The tray comprising a layer comprising potassium sorbate and sodium benzoate can be obtained by a process comprising:
i) mixing at least one polymer and potassium sorbate and extruding the mixture to form an active formulation A,
ii) mixing at least one polymer and sodium benzoate and extruding the mixture to form an active formulation B; and
iii) submitting the active formulations A and B to cast-coextrusion with at least one polymer, which can be the same as or different to either the at least one polymer of the active formulation A or B, in order to obtain a structure of at least two layers comprising a structural layer and an active layer of a polymeric matrix comprising potassium sorbate and sodium benzoate.

As an instance, the at least one polymer in formulation A is equal to the at least one polymer in formulation B and is a mixture of ethylene vinyl acetate (EVA) and polypropylene (PP). Additionally, at least one anti-fog compound can be incorporated either in steps i) or ii).

The packaging material of the invention is particularly suitable for preserving peeled and/or cut fresh fruits, such as pineapples, oranges, mandarins, kiwis, watermelons, melons, strawberries, apples, peaches, pears raspberry, blueberry, banana, mango, grape, and avocado, or vegetables.

Accordingly, as commented above, the invention also relates to method for the conservation of foodstuff, particularly of minimally processed fruits and vegetables, more particularly of fresh peeled and/or cut fruits or vegetables, by the use of the packaging material of the invention.

In a particular embodiment, optionally in combination with one or more features of the particular embodiments defined above or below, the foodstuff is a fresh peeled and/or cut fruit selected from the group consisting of pineapples, oranges, mandarins, kiwis, watermelons, melons, strawberries, apples, peaches, pears raspberry, blueberry, banana, mango, grape, and avocado.

By the use of the method of the invention, shelf life of particularly of minimally processed fruits and vegetables, more particularly of fresh peeled and/or cut fruits or vegetables, can be increased from 3 to 5 extra days, or even more (see Example 17 where pineapple conserved their good appearance after 7 days).

Throughout the description and claims the word “comprise” and variations of the word, are not intended to exclude other technical features, additives, components, or steps. Furthermore, the word “comprise” encompasses the case of “consisting of”. The following examples and drawings are provided by way of illustration, and they are not intended to be limiting of the present invention. Furthermore, the present invention covers all possible combinations of particular and preferred embodiments described herein.

### EXAMPLES

### Example 1.—Evaluation of Synergistic Effect of Citral, Hexanal and Linalool

Saccharomyces cerevisiae CECT 13084, Aspergillus niger CECT 2807 and Penicillium aurantiogriseum CECT 2264 were obtained from Colección Española de Cultivos tipo (CECT, Valencia, Spain). These microorganisms were selected as common spoilage microorganisms of fruit according to bibliographic data.

50 μl of yeast and moulds inoculum (7 log CFU/ml yeast and 10⁶ spores/ml molds) were cultured on MEA agar Petri dishes. Sterilized square piece of paper (2×2 cm²) were placed on the lid of the Petri dish and impregnated individually with citral, hexanal and linalool mixture (equal volume 1:1:1, (from 1 to 30 μL). Petri dishes were sealed with Parafilm® to reduce volatiles losses. Inoculated agar plates without active agents were included as reference control. Plates were incubated at 25° C. for 3 days. After the incubation period, qualitative analysis was carried out by visual inspection. The minimum amount in μL that complete inhibited the growth of the microorganisms (Cmax) was used for the Fractioning Index Concentration (FIC) calculation, equivalent to the Sinergy Index (SI). Tests were performed in triplicate.

The FIC index for the combination of 3 compounds was calculated as the sum of their individual FIC values as described in equation 1, wherein V is the minimum volume of the specified compound that complete inhibited the growth of the microorganisms either alone or when used in combination with the other two active agents.

$$FIC = \frac{V citral mix}{V citral alone} + \frac{V hexanal mix}{V hexanal alone} + \frac{V linalool mix}{V linalool alone}$$

FIC values below 1 were considered synergistic effects, values equal to 1 were considered additive effect, values between 1 and 2 were set as indifferent effect, and values above 2 were considered antagonistic effect. Results of the FIC for Sacharomyces cerevisiae, Aspergillus niger and Penicillium aurantiogriseum are shown in Table 1.

TABLE 1
Fractioning Index Concentration (FIC) for the mixture
citral (C), hexanal (H) y linalool (L) (ratio 1:1:1)

| | V active agent in mixture (μL)/V | | | | | |
|---|---|---|---|---|---|---|
| | active agent alone (μL) | | | FIC | | |
| Microorganism | Citral | Hexanal | Linalool | C:H:L | p value | Effect |
| Saccharomyces | 0.33 | 0.17 | 0.11 | 0.61 | 0.00 | <1 |
| cerevisiae | | | | | | Synergistic |
| Penicillium | 0.33 | 0.33 | 0.11 | 0.78 | 0.00 | <1 |
| aurantiogriseum | | | | | | Synergistic |
| Aspergillus | 0.33 | 0.33 | 0.22 | 0.89 | 0.00 | <1 |
| niger | | | | | | Synergistic |

*p value < 0.05 means that there is a significant difference between the FIC values and 1.00

In the present study, significant synergistic effects were observed for the mixture citral:hexanal:linalool for the ratio 1:1:1 with FIC values below 1 and p value<0.05 for all the microorganisms assayed.

### Example 2-10

Examples 2-10, corresponding to combinations comprising different ratios of citral, hexanal and linalool were carried out in order to prove synergistic effect at other ratios of the three active components besides the one in Example 1. Comparative Examples with a 100% of each one of the active components were also carried out to calculate FIC index (see above). Finally, a control was performed without any active compound. The combinations are shown in Table 2.

TABLE 1
Different combinations of citral, hexanal and linalool to prove synergistic
effect at other ratios of the three active components besides the one in
Example 1

| Example | Citral | Hexanal | Linalool |
|---|---|---|---|
| Ex. 2 | 17.2 | 65.7 | 17.2 |
| Ex. 3 | 49.5 | 1 | 49.5 |
| Ex. 4 | 90 | 5 | 5 |
| Ex. 5 | 1 | 49.5 | 49.5 |
| Ex. 6 | 17.2 | 17.2 | 65.7 |
| Ex. 7 | 49.5 | 49.5 | 1 |
| Ex. 8 | 65.7 | 17.2 | 17.2 |
| Ex. 9 | 5 | 90 | 5 |
| Ex. 10 | 5 | 5 | 90 |
| Comp. Ex. 1 | 100 | 0 | 0 |
| Comp. Ex. 2 | 0 | 100 | 0 |
| Comp. Ex. 3 | 0 | 0 | 100 |
| Control | 0 | 0 | 0 |

Specifically, all Examples, Comparative Examples and the Control were tested to calculate FIC index for moulds and yeast (similarly as Example 1) and additionally for bacteria. In particular, next microorganisms were tested:
Moulds: Aspergillus Niger, Penicillium aurantiogriseum
Yeast: Saccharomyces cerevisiae.
Bacteria: Escherichia coli (Gram −), Listeria innocua (Gram +)

Microbiology analysis were performed similarly as described in Example 1. Specifically, in these cases, filter papers between 2×2-4×4 cm were used and incubation conditions were 37° C. for 24 h in case of the bacteria.

TABLE 2
Fractioning Index Concentration (FIC) of the studied combinations of
citral (C), hexanal (H) and linalool (L) for Aspergillus niger

| | V active agent | | | | |
|---|---|---|---|---|---|
| Microorganism | in mixture (μL)/ | | | | |
| Aspergillus | V active agent alone (μL) | | | FIC | |
| niger | Citral | Hexanal | Linalool | C:H:L | Effect |
| Ex. 2 | 0.06 | 0.33 | 0.02 | 0.41 | <1 Synergistic |
| Ex. 3 | 0.66 | 0.02 | 0.25 | 0.93 | <1 Synergistic |
| Ex. 4 | 0.90 | 0.08 | 0.02 | 0.99 | <1 Synergistic |
| Ex. 5 | 0.01 | 0.74 | 0.19 | 0.94 | <1 Synergistic |
| Ex. 6 | 0.17 | 0.26 | 0.25 | 0.68 | <1 Synergistic |
| Ex. 7 | 0.17 | 0.25 | 0.00 | 0.41 | <1 Synergistic |
| Ex. 8 | 0.44 | 0.17 | 0.04 | 0.65 | <1 Synergistic |
| Ex. 9 | 0.03 | 0.90 | 0.01 | 0.95 | <1 Synergistic |
| Ex. 10 | 0.10 | 0.15 | 0.68 | 0.93 | <1 Synergistic |

TABLE 3
Fractioning Index Concentration (FIC) of the studied combinations of
citral (C), hexanal (H) and linalool (L) for Penicillium aurantiogriseum

| | V active agent | | | | |
|---|---|---|---|---|---|
| Microorganism | in mixture (μL)/V | | | | |
| Penicillium | active agent alone (μL) | | | FIC | |
| aurantiogriseum | Citral | Hexanal | Linalool | C:H:L | Effect |
| Ex. 2 | 0.11 | 0.66 | 0.04 | 0.81 | <1 Synergistic |
| Ex. 3 | 0.66 | 0.02 | 0.25 | 0.93 | <1 Synergistic |
| Ex. 4 | 0.60 | 0.05 | 0.01 | 0.66 | <1 Synergistic |
| Ex. 5 | 0.01 | 0.50 | 0.12 | 0.63 | <1 Synergistic |
| Ex. 6 | 0.17 | 0.26 | 0.25 | 0.68 | <1 Synergistic |
| Ex. 7 | 0.17 | 0.25 | 0.00 | 0.41 | <1 Synergistic |
| Ex. 8 | 0.44 | 0.17 | 0.04 | 0.65 | <1 Synergistic |
| Ex. 9 | 0.02 | 0.45 | 0.01 | 0.47 | <1 Synergistic |

TABLE 4
Fractioning Index Concentration (FIC) of the studied combinations of
citral (C), hexanal (H) and linalool (L) for Saccharomyces cerevisiae

| | V active agent | | | | |
|---|---|---|---|---|---|
| Microorganism | in mixture (μL)/V | | | | |
| Saccharomyces | active agent alone (μL) | | | FIC | |
| cerevisiae | Citral | Hexanal | Linalool | C:H:L | Effect |
| Ex. 2 | 0.17 | 0.33 | 0.04 | 0.54 | <1 Synergistic |
| Ex. 3 | 0.74 | 0.01 | 0.19 | 0.94 | <1 Synergistic |
| Ex. 4 | 0.45 | 0.01 | 0.01 | 0.47 | <1 Synergistic |
| Ex. 5 | 0.02 | 0.37 | 0.19 | 0.57 | <1 Synergistic |
| Ex. 6 | 0.26 | 0.13 | 0.25 | 0.63 | <1 Synergistic |
| Ex. 7 | 0.25 | 0.12 | 0.00 | 0.37 | <1 Synergistic |
| Ex. 8 | 0.66 | 0.09 | 0.04 | 0.79 | <1 Synergistic |
| Ex. 9 | 0.05 | 0.45 | 0.01 | 0.51 | <1 Synergistic |
| Ex. 10 | 0.05 | 0.03 | 0.23 | 0.30 | <1 Synergistic |

TABLE 5
Fractioning Index Concentration (FIC) of the studied combinations of
citral (C), hexanal (H) y linalool (L) for Escherichia coli

| | V active agent | | | | |
|---|---|---|---|---|---|
| | in mixture (μL)/V | | | | |
| Microorganism | active agent alone (μL) | | | FIC | |
| Escherichia coli | Citral | Hexanal | Linalool | C:H:L | Effect |
| Ex. 2 | 0.03 | 0.44 | 0.07 | 0.54 | <1 Synergistic |
| Ex. 4 | 0.45 | 0.10 | 0.06 | 0.61 | <1 Synergistic |
| Ex. 5 | 0.00 | 0.50 | 0.30 | 0.79 | <1 Synergistic |
| Ex. 7 | 0.08 | 0.33 | 0.00 | 0.42 | <1 Synergistic |
| Ex. 8 | 0.33 | 0.34 | 0.21 | 0.88 | <1 Synergistic |
| Ex. 9 | 0.01 | 0.90 | 0.03 | 0.94 | <1 Synergistic |

TABLE 6
Fractioning Index Concentration (FIC) of the studied combinations of
citral (C), hexanal (H) and linalool (L) for Listeria innocua

| | V active agent | | | | |
|---|---|---|---|---|---|
| | in mixture (μL)/V active | | | | |
| Microorganism | agent alone (μL) | | | FIC | |
| Listeria innocua | Citral | Hexanal | Linalool | C:H:L | Effect |
| Ex. 4 | 0.60 | 0.01 | 0.02 | 0.63 | <1 Synergistic |
| Ex. 5 | 0.02 | 0.37 | 0.50 | 0.89 | <1 Synergistic |
| Ex. 6 | 0.23 | 0.09 | 0.44 | 0.75 | <1 Synergistic |
| Ex. 7 | 0.66 | 0.25 | 0.01 | 0.91 | <1 Synergistic |

### Example.11—Manufacture of an Active Lid

The active lid is a bi-layer structure made of:
An external layer (structural layer): polypropylene (PP)
An inner layer (active layer): PP+volatile active agents

The inner layer is the one that will be disposed in the interior side of the package and will allow the active agents to be released in the head space where the foodstuff is confined. The active agents are a volumetric mixture of citral, hexanal, linalool (CHL, 1:1:1).

The active lid manufacturing process has been carried out in 2 steps:

Step 1).—Compounding

PP composite containing 8.5% (w/w) of citral:hexanal:linalool (CHL, 1:1:1) (nominal concentration) was produced using a ZSK 26 Mc (Coperion) twin screw extruder. The final concentration of citral:hexanal:linalool in the PP compound was 8.05% (w/w) assuming approximately 5% of losses during compounding processing.

Step 2).—Cast-Coextrusion

An active PP bi-layer lid was obtained with a Dr Collin coextrusion line. The active lid film obtained is a bi-layer structure of polypropylene where the inner layer (disposed in the interior side of the package and will allow the active agents to be released in the head space where the foodstuff is confined) is the active layer containing the active compounds (CHL, 1:1:1) and the structural layer is based in raw polypropylene.

The following structures having different thickness (ranging from 80 to 100 μm) were developed, wherein the concentration of the active agents ranges from 3.5 to 5% (w/w):
Composition 1.1. 60 μm PP/40 μm CHL, 1:1:1 (3.4 wt. %; 3.2 g/m²)
Composition 1.2. 30 μm PP/70 μm CHL, 1:1:1 (5.7 wt. %; 5.4 g/m²)
Composition 1.3. 10 μm PP/70 μm CHL, 1:1:1 (7 wt. %; 5.3 g/m²)

The antimicrobial effect of the lid will be due to the release of the volatile active agents to the head space of the packed fruit.

### Example 12.—Antimicrobial Properties of the Films In Vitro (4° C./12 Days)

The antimicrobial effectiveness of the following materials was studied in vapour phase:
Control: PP100 without active compounds: 100 μm PP
PP60/40a_8.5% CHL bilayer: (60 μm PP/40 μm CHL, 1:1:1 in PP)
PP30/70a_8.5% CHL bilayer: (30 μm PP/70 μm CHL, 1:1:1 in PP)

50 μL of bacterial inoculum, A. niger, P. aurantiogriseum and S. cerevisiae were cultured on malt extract agar (MEA) Petri dishes and active and control films (5 cm×5 cm) were fixed on the lid of the Petri dishes. Petri dishes were sealed with parafilm to reduce loss of volatiles. Moulds and yeast were incubated for 12 days at 4° C.

Due to the low mycelial formation and the difficulty to observe an inhibition zone at 4° C. after the incubation period, the agar was collected, homogenized and re-plated for quantitative analysis. Results are shown in Table 8.

TABLE 8
Antimicrobial activity of bilayer active films in vapor phase diffusion
method against Saccharomyces cerevisiae, Penicillium aurantiogriseum
and Aspergillus niger at 4° C. after 12 days.

| | Saccharomyces | | Penicillium | | Aspergillus | |
|---|---|---|---|---|---|---|
| | cerevisiae | | aurantiogriseum | | niger | |
| | log (CFU/ | log | log (CFU/ | log | log (CFU/ | log |
| Reference | mL) ± SD | reduction | mL) ± SD | reduction | mL) ± SD | reduction |
| PP100 (control) | 4.82 ± 0.03 ^{a} | — | 4.03 ± 0.03 ^{a} | — | 3.53 ± 0.05 ^{a} | — |
| PP60/40a_8.5% | 4.16 ± 0.05 ^{b} | 0.66* | 3.39 ± 0.20 ^{b} | 0.64* | 3.08 ± 0.06 ^{b} | 0.45* |
| CHL | | | | | | |
| PP30/70a_8.5% | 4.01 ± 0.16 ^{b} | 0.81* | 2.71 ± 0.16 ^{c} | 1.32* | 2.10 ± 0.13 ^{c} | 1.44* |
| CHL | | | | | | |

Values within the same column with a different superscript letter are significantly different at p ≤ 0.05 (Tukey analysis).
Detection limit = 1.85 log CFU/g
*Significant log CFU/g reduction

The antimicrobial effectiveness of the films was straight related with the concentration of the active agents in the film. The film with higher active layer thickness (PP30/70a_8.5% CHL) showed the highest activity against the target microorganisms.

### Example 13.—In Vivo Assays of the Antimicrobial Films in Minimally Processed Orange and Pineapple

Active films developed (PP60/40a_8.5% CHL, PP30/70a_8.5% CHL, PP10/70a_8.5% CHL) and their corresponding controls (PP100 and PP80) were validated in fresh cut pineapple and orange. Physiochemical properties (°Brix, pH, juice leakage, visual quality), respiration rates, microbial counts of orange and pineapple packaged with antimicrobial and control films were evaluated. Peeled and cut orange or pineapple were packaged with control PP and active films which were perforated with 2 holes of 250 μm to allow the gas exchange with the environment and avoid anaerobic conditions. PP blank trays were used as a holder to pack the fruit. Orange and pineapple were packed under air conditions. Packed samples were stored at 4° C. for 7 days followed by 5 days at 8° C. in order to simulate abuse temperatures that can occur along the supply chain.

Antimicrobial Properties

The peeled and cut pineapple and orange were subjected to microbiological analyses along the storage period. The microflora of the fruit packed with active films (PP60/40a_8.5% CHL, PP30/70a_8.5% CHL and PP10/70a_8.5% CHL) and control films (P100 and P80) with no active agents was evaluated by day 0, 3, 7 and 12 in terms of total aerobic count, molds and yeast and psychrotrophic bacteria. For PP10/70a_8.5% CHL film, day 5 and 10 were also analyzed. Day 0 was defined as the microbial load of the fruit before packaging.

Table 9 and Table 10 show the microbial enumeration of pineapple and orange along the storage period. Reported results are the mean of three replicates±standard deviation. Statistical differences on the microbial enumeration within days and cultivars in pineapple and orange among the different films were evaluated through ANOVA and Tukey analysis.

TABLE 9
Enumeration of microbial population of peeled cut pineapple packed with active and control films
stored at 4° C. for 7 days followed by 5 days at 8° C.
Pineapple

| | Total aerobic counts (log CFU/g) | | | Total aerobic counts (log CFU/g) | |
|---|---|---|---|---|---|
| Day | P100 (control) | PP60/40a_8.5% CHL | PP30/70a_8.5% CHL | P80 (control) | PP10/70a_8.5% CHL |
| 0 | 4.33 ± 0.11 | | | 4.84 ± 0.58 | |
| 3 | 4.15 ± 0.18^{a} | 3.71 ± 0.14^{b} | 3.89 ± 0.13^{ab} | 5.36 ± 0.01 | 5.43 ± 0.02 |
| 5 | — | — | — | 5.46 ± 0.20^{a} | 4.48 ± 0.15^{b} |
| 7 | 5.41 ± 0.38^{a} | 4.49 ± 0.23^{b} | 4.05 ± 0.17^{b} | 5.99 ± 0.21^{a} | 4.73 ± 0.12^{b} |
| 10 | — | — | — | 6.44 ± 0.14^{a} | 6.07 ± 0.39^{a} |
| 12 | 7.06 ± 0.03^{a} | 7.04 ± 0.04^{a} | 6.09 ± 0.05^{b} | 6.69 ± 0.41^{a} | 6.32 ± 0.11^{a} |
| | Molds and yeasts (log CFU/g) | | | Molds and yeasts (log CFU/g) | |
| Day | P100 (control) | PP60/40a_8.5% CHL | PP30/70a_8.5% CHL | P80 (control) | PP10/70a_8.5% CHL |
| 0 | 4.12 ± 0.24 | | | 4.29 ± 0.12 | |
| 3 | 5.47 ± 0.17^{a} | 4.17 ± 0.18^{b} | 4.25 ± 0.39^{b} | 6.01 ± 0.23^{a} | 5.00 ± 0.29^{b} |
| 5 | — | — | — | 6.55 ± 0.44^{a} | 5.33 ± 0.43^{b} |
| 7 | 7.35 ± 0.19^{a} | 5.82 ± 0.04^{b} | 5.94 ± 0.12^{b} | 8.06 ± 0.10^{a} | 6.06 ± 0.06^{b} |
| 10 | — | — | — | 8.34 ± 0.05^{a} | 8.28 ± 0.01^{a} |
| 12 | 8.57 ± 0.11^{a} | 8.10 ± 0.05^{b} | 7.87 ± 0.19^{b} | 8.53 ± 0.03^{a} | 8.34 ± 0.01^{b} |
| | Psychrotrophic bacteria (log CFU/g) | | | Psychrotrophic bacteria (log CFU/g) | |
| Day | P100 (control) | PP60/40a_8.5% CHL | PP30/70a_8.5% CHL | P80 (control) | PP10/70a_8.5% CHL |
| 0 | 4.27 ± 0.24 | | | 2.76 ± 0.08 | |
| 3 | 5.34 ± 0.11^{a} | 3.91 ± 0.11^{b} | 4.14 ± 0.51^{b} | 5.97 ± 0.20^{a} | 4.87 ± 0.24^{b} |
| 5 | — | — | — | 6.67 ± 0.53^{a} | 4.69 ± 0.50^{b} |
| 7 | 6.73 ± 0.08^{a} | 5.85 ± 0.05^{b} | 5.11 ± 0.28^{c} | 7.77 ± 0.01^{a} | 6.05 ± 0.04^{b} |
| 10 | — | — | — | 8.23 ± 0.03^{a} | 8.22 ± 0.09^{a} |
| 12 | >6.83 | >6.83 | >6.83 | 8.40 ± 0.16^{a} | 8.25 ± 0.03^{a} |

*Values among same day of analysis with a different superscript letter are significantly different at p ≤ 0.05 (Tukey analysis). Statistical analysis was performed individually for each cultivar.
**DL = 1.6 log CFU/g
(—) Unperformed test

TABLE 10
Enumeration of microbial population of peeled cut orange packed with active and control films stored
at 4° C. for 7 days followed by 5 days at 8° C.
Orange

| | Total aerobic counts (log CFU/g) | | | Total aerobic counts (log CFU/g) | |
|---|---|---|---|---|---|
| Day | P100 (control) | PP60/40a_8.5% CHL | PP30/70a_8.5% CHL | P80 (control) | PP10/70a_8.5% CHL |
| 0 | 3.12 ± 0.07 | | | 4.49 ± 0.75 | |
| 3 | 3.59 ± 0.04^{a} | 3.31 ± 0.01^{a} | 3.34 ± 0.26^{a} | 4.75 ± 0.19^{a} | 4.38 ± 0.02^{b} |
| 5 | — | — | — | 4.74 ± 0.07^{a} | 4.63 ± 0.12^{a} |
| 7 | 4.86 ± 0.04^{a} | 4.44 ± 0.27^{ab} | 4.30 ± 0.29^{b} | 5.66 ± 0.16^{a} | 5.29 ± 0.13^{b} |
| 10 | — | — | — | 6.91 ± 0.20^{a} | 6.83 ± 0.25^{a} |
| 12 | 7.41 ± 0.28^{a} | 6.36 ± 0.07^{b} | 6.48 ± 0.16^{b} | 6.93 ± 0.18^{a} | 6.71 ± 0.17^{a} |
| | Molds and yeasts (log CFU/g) | | | Molds and yeasts (log CFU/g) | |
| Day | P100 (control) | PP60/40a_8.5% CHL | PP30/70a_8.5% CHL | P80 (control) | PP10/70a_8.5% CHL |
| 0 | 2.89 ± 0.01 | | | 3.45 ± 0.02 | |
| 3 | 4.82 ± 0.11^{a} | 4.27 ± 0.20^{b} | 4.16 ± 0.09^{b} | 5.62 ± 0.16^{a} | 5.01 ± 0.12^{b} |
| 5 | — | — | — | 6.07 ± 0.15^{a} | 5.87 ± 0.16^{a} |
| 7 | 6.55 ± 0.22^{a} | 5.93 ± 0.43^{b} | 5.69 ± 0.06^{b} | 7.16 ± 0.22^{a} | 6.83 ± 0.06^{a} |
| 10 | — | — | — | 8.33 ± 0.07^{a} | 8.21 ± 0.15^{a} |
| 12 | 9.33 ± 0.05^{a} | 8.06 ± 0.16^{b} | 7.13 ± 0.16^{c} | 8.46 ± 0.03^{a} | 8.19 ± 0.13^{b} |
| | Psychrotrophic bacteria (log CFU/g) | | | Psychrotrophic bacteria (log CFU/g) | |
| Day | P100 (control) | PP60/40a_8.5% CHL | PP30/70a_8.5% CHL | P80 (control) | PP10/70a_8.5% CHL |
| 0 | 3.33 ± 0.03 | | | 2.73 ± 0.23 | |
| 3 | 4.97 ± 0.12^{a} | 4.43 ± 0.24^{b} | 4.43 ± 0.14^{b} | 5.72 ± 0.14^{a} | 5.09 ± 0.10^{b} |
| 5 | — | — | — | 6.29 ± 0.21^{a} | 6.18 ± 0.21^{a} |
| 7 | 6.39 ± 0.13^{a} | 6.27 ± 0.13^{a} | 4.75 ± 0.05^{b} | 7.14 ± 0.15^{a} | 6.96 ± 0.10^{a} |
| 10 | — | — | — | 8.40 ± 0.03^{a} | 8.29 ± 0.18^{a} |
| 12 | 7.80 ± 0.02 | >6.83 | >6.83 | 8.52 ± 0.06^{a} | 8.28 ± 0.13^{b} |

*Values among same day of analysis within the same row and with a different superscript letter are significantly different at p ≤ 0.05 (Tukey analysis). Statistical analysis were performed individually for each cultivar.
**DL = 1.6 log CFU/g

From Table 9 and Table 10, microbial log CFU/g reductions achieved in pineapple and orange, respectively, for each active film in regard to their corresponding film control were calculated for each day of analysis as shown in Table 11 and Table 12.

TABLE 11
Antimicrobial effectiveness of bilayer active films on pineapple
expressed as log CFU/g reduction regarding control films.

| | Pineapple | | |
|---|---|---|---|
| | PP60/ | | |
| Day | 40a_8.5% CHL | PP30/70a_8.5% CHL | PP10/70a_8.5% CHL |
| | Log reduction total aerobic count (log CFU/g) | | |
| 3 | 0.44* | 0.26 | 0 |
| 5 | — | — | 0.98* |
| 7 | 0.92* | 0.98* | 1.26* |
| 10 | — | — | 0.37 |
| 12 | 0 | 0.99* | 0.37 |
| | Log reduction molds and yeasts (log CFU/g) | | |
| 3 | 1.30* | 1.21* | 1.01* |
| 5 | — | — | 1.22* |
| 7 | 1.53* | 1.41* | 2.00* |
| 10 | — | — | 0.06 |
| 12 | 0.47 * | 0.7* | 0.18* |
| | Log reduction psychrotrophic bacteria (log CFU/g) | | |
| 3 | 1.43* | 1.20* | 1.10* |
| 5 | — | — | 1.98* |
| 7 | 0.88* | 1.49* | 1.72* |
| 10 | — | — | 0.01 |
| 12 | --- | --- | |

*significant log reductions
(—) not tested
(---) values out of the counting range

TABLE 12
Antimicrobial effectiveness of bilayer active films on orange
expressed as log reduction values regarding control films.

| | Orange | | |
|---|---|---|---|
| | PP60/ | | |
| Day | 40a_8.5% CHL | PP30/70a_8.5% CHL | PP10/70a_8.5% CHL |
| | Log reduction total aerobic count (log CFU/g) | | |
| 3 | 0.29 | 0.25 | 0.37* |
| 5 | — | — | 0.11 |
| 7 | 0.42 | 0.56* | 0.37* |
| 10 | — | — | 0.08 |
| 12 | 1.05* | 0.93* | 0.22 |
| | Log reduction molds and yeasts (log CFU/g) | | |
| 3 | 0.55* | 0.66* | 0.61* |
| 5 | — | — | 0.20 |
| 7 | 0.62* | 0.86* | 0.33 |
| 10 | — | — | 0.12 |
| 12 | 1.27* | 2.20* | 0.27* |
| | Log reduction psychrotrophic bacteria (log CFU/g) | | |
| 3 | 0.53* | 0.54* | 0.62* |
| 5 | — | — | 0.11 |
| 7 | 0.13 | 1.64* | 0.18 |
| 10 | — | — | 0.11 |
| 12 | <0.97 | <0.97 | 0.25* |

*Significant log reduction
(—) not tested

In general, microbial loads of pineapple and orange were significant lower (p≤0.05) when packed with active films compared with the film control. Particularly in pineapple, the maximum microbial load reduction was generally observed at day 7 before the shift of temperature from 4° C. to 8° C. occurred.

On the whole, active films showed higher activity in the inhibition of the microbial growth in pineapple than in orange.

Sensory Evaluation

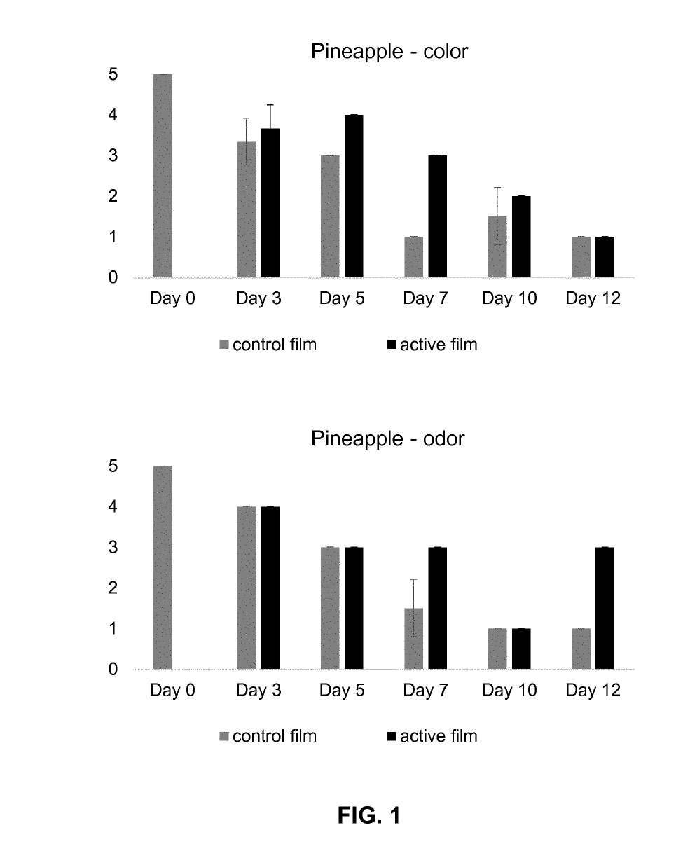

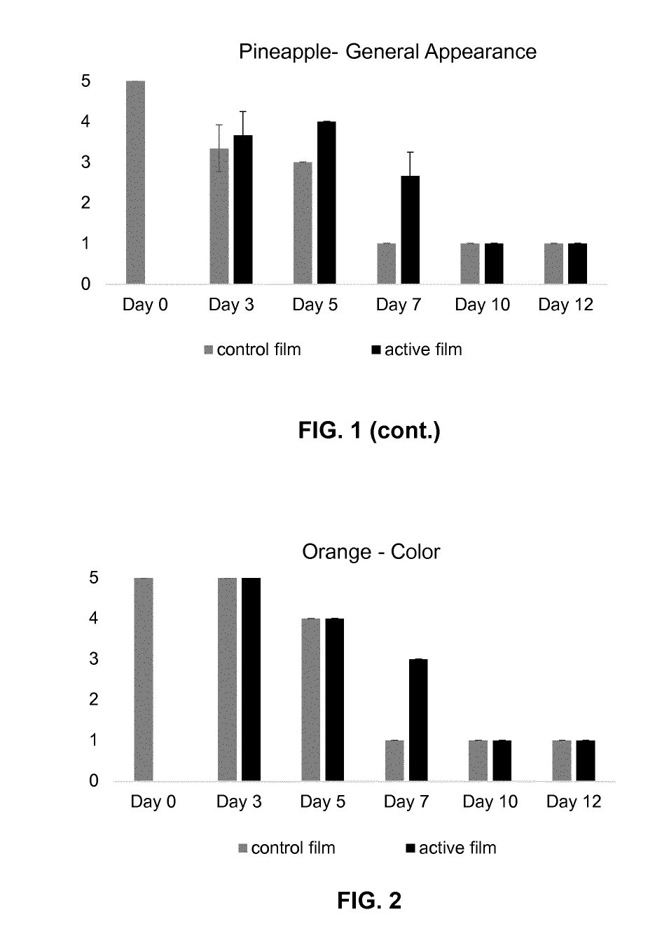

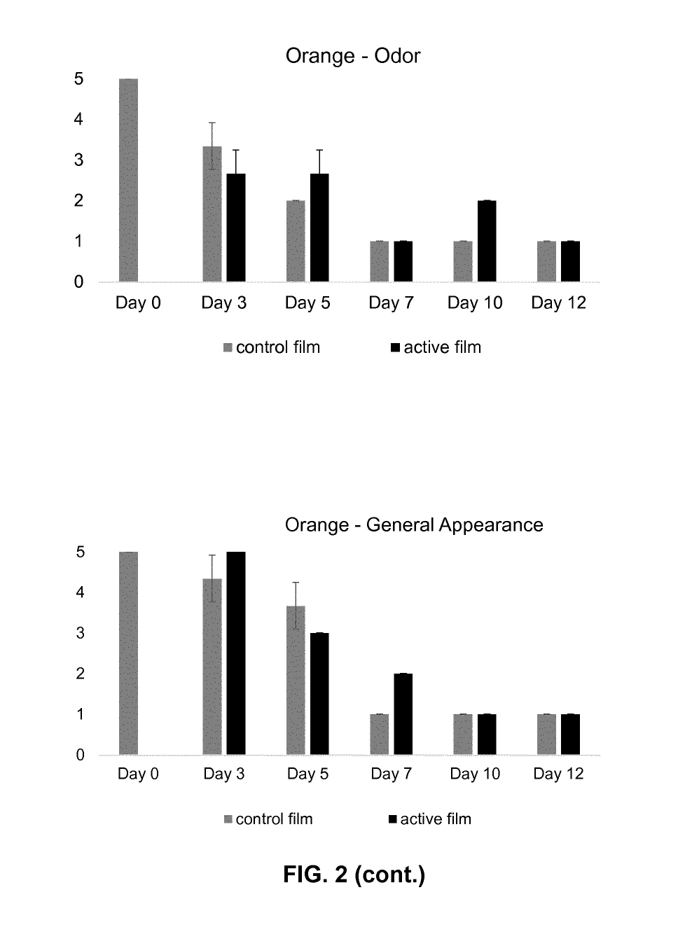

A sensory evaluation test was carried out by 10 consumers panel who scored the visual quality (color and general appearance) and also the odor perception of peeled and cut orange and pineapple packed with control (PP80) and active films PP10/70a_8.5% CHL stored at 4° C. for 7 days followed by 5 days at 8° C. Ratings were based on a 5-point hedonic scale where 5 was very good, 4 was good, 3 was fair (limit of marketability), 2 was poor and 1 was bad (unusable). FIG. 1 and FIG. 2 shows the sensory parameters color, odor and general appearance evaluated for pineapple and orange respectively along the storage period.

In general, pineapple and orange packed with active film was higher scored compared with pineapples packed with control films along the storage period.

### Example 14.—Manufacture of an Active Tray

The active tray had a bi-layer structure made of:
An external layer (structural layer): polypropylene (PP)
An inner layer in contact with food (active layer): PP+EVA+solid preservatives

The solid preservatives are a mixture of potassium sorbate (E-202) and sodium benzoate (E-211). These active agents are non-volatile compounds with antimicrobial properties. The selected ratio of the two active compounds was 60 parts of potassium sorbate and 40 parts of sodium benzoate which according to the literature was demonstrated to have the best antimicrobial effectiveness.

The active tray manufacturing process is described below:

Step 1).—Compounding

To carry out the composite processing, a ZSK 26 Mc (Coperion) twin screw extruder was used.

Due to differences in density, each salt was mixed with the PP and 10% EVA separately. Thus, the following two different compositions were prepared:
Polypropylene+10% ethylene vinyl acetate (EVA)+24% potassium sorbate
Polypropylene+10% ethylene vinyl acetate (EVA)+16% sodium benzoate

Step 2).—Cast-Coextrusion

A Dr Collin coextrusion line was used to obtain a bilayer containing PP (external layer; 580 μm) and PP+10% EVA with 20% of potassium sorbate (PS) and sodium benzoate (SB) in a ratio 60:40 (internal layer; 100 μm).

Step 3).—Thermoforming

Thermoforming trials were carried out at laboratory scale using a table top vacuum thermoforming machine (FORMECH 450).

In contrast with the active lid, the antimicrobial effect of this tray will be due to the release of the active compounds in contact with the fruit or its exudate.

### Example 15.—Antimicrobial Properties of the Active Tray In Vitro

The antimicrobial activity of the active extruded trays was evaluated against Saccharomyces cerevisiae, Aspergillus niger and Penicillium aurantiogriseum at 25° C. in potato dextrose broth. Table 13 shows the antimicrobial properties of the active trays at 25° C.

TABLE 13
Antimicrobial properties of active PP/PP_EVA_20% S:B trays in PDB at 25° C. for 7 days.

| | Saccharomyces | | Penicillium | | Aspergillus | |
|---|---|---|---|---|---|---|
| | cerevisiae | | aurantiogriseum | | niger | |
| | log (CFU/ | log | log (CFU/ | log | log (CFU/ | log |
| Reference | mL) ± SD | reduction | mL) ± SD | reduction | mL) ± SD | reduction |
| PP/PP:10% | 6.35 ± 0.07^{a} | | 6.45 ± 0.05 ^{a} | | 6.18 ± 0.07 ^{a} | |
| EVA tray | | | | | | |
| PP/PP:10% | 4.89 ± 0.25 ^{b} | 1.46* | 2.88 ± 0.09 ^{b} | 3.57* | 1.15 ± 0.21 ^{b} | 5.03* |
| EVA:20% PS_SB | | | | | | |
| tray | | | | | | |

Values within the same column with a different superscript letter are significantly different at p ≤ 0.05 (Tukey analysis).
DL = 1.3 log CFU/mL
*Significant log CFU/g reduction

As can be observed, the active extruded trays present a strong effectiveness against the studied moulds in comparison with the control tray (3.57 log reduction for P. aurantiogriseum and 5.03 log reduction for A. niger) and also reduction in the growth of S. cerevisiae (1.46 log CFU/ml).

The same test was performed at refrigeration temperature (4° C.) for 12 days. Results are shown in Table 14

TABLE 14
Antimicrobial properties of active PP/PP + EVA_20% S:B trays at 4° C. for 12 days

| | Saccharomyces | | Penicillium | | Aspergillus | |
|---|---|---|---|---|---|---|
| | cerevisiae | | aurantiogriseum | | niger | |
| | log (CFU/ | log | log (CFU/ | log | log (CFU/ | log |
| Reference | mL) ± SD | reduction | mL) ± SD | reduction | mL) ± SD | reduction |
| PP/PP:10% | 6.07 ± 0.12 | | 2.20 ± 0.39 | | 3.29 ± 0.39 | |
| EVA tray | | | | | | |
| PP/PP:10% | 5.15 ± 0.10 | 0.92* | 2.35 ± 0.14 | — | 3.07 ± 0.06 | 0.22 |
| EVA:20% PS_SB | | | | | | |
| tray | | | | | | |

Values within the same column with a different superscript letter are significantly different at p ≤ 0.05 (Tukey analysis).
DL = 1.3 log CFU/mL
*Significant log CFU/g reduction
— No reduction

Active trays exerted a significant reduction against Saccharomyces cerevisiae with around 1 log reduction. No significant effect was observed for the studied molds Penicillium aurantiogriseum and Aspergillus niger due to the difficulty in measuring their growth in liquid media.

Gravimetrical biomass tests were also performed in order to correct the possible error made in the previous test. This test was done only for Penicillium aurantiogriseum since Aspergillus niger did not produce visible biomass. Results obtained in this gravimetrical test showed a reduction of 47% (w/w) of biomass growth was achieved compared to the biomass of Penicillium quantified in the tray control.

### Example 16.—In Vivo Assays of the Active Trays in Peeled and Cut Orange and Pineapple

Active trays were validated for fresh cut pineapple and orange. Respiration rates, microbial counts, and visual quality of orange and pineapple packaged with antimicrobial and control trays were evaluated. Peeled and cut orange or pineapple was packaged with control PP films in combination with control and active trays. Films were perforated with 2 holes of 250 μm to allow the gas exchange with the environment and avoid anaerobic conditions. Fruit was packaged under air conditions and stored at 4° C. for 7 days followed by 3 days at 8° C. in order to simulate abuse temperatures that can occur along the supply chain.

Antimicrobial Properties

The peeled cut fruit was subjected to microbiological analyses along the storage period at 4/8° C. The microflora of the fruit packed with active and control trays was evaluated by day 0, 3, 7 and 10 in terms of total aerobic count, moulds and yeast and psychrotrophic bacteria. Day 0 was defined as microbial load before the packaging process.

Table 15 and Table 16 show the evolution of the microbial growth of pineapple and orange, respectively, along the storage period packaged with control and active trays.

TABLE 15
Enumeration of microbial population and log CFU/g reduction of
peeled cut pineapple packed with control and active trays stored
at 4° C. for 7 days followed by 3 days at 8° C.

| | Pineapple | | |
|---|---|---|---|
| | Total aerobic counts (log CFU/g) | | |
| | | PP/ | Reduction total |
| | PP/PP:10% EVA | PP:10% EVA:20% PS_SB | aerobic counts |
| Day | tray | tray | (log CFU/g) |
| 0 | 4.68 ± 0.10 | | |
| 3 | 5.14 ± 0.04^{a} | 4.78 ± 0.23^{a} | 0.36 |
| 7 | 4.49 ± 0.08^{a} | 4.16 ± 0.18^{b} | 0.33* |
| 10 | 5.33 ± 0.09^{a} | 4.89 ± 0.25^{b} | 0.43* |
| | Molds and yeasts (log CFU/g) | | |
| | | PP/ | Reduction molds |
| | PP/PP:10% EVA | PP:10% EVA:20% PS_SB | and yeasts |
| Day | tray | tray | (log CFU/g) |
| 0 | 4.40 ± 0.24 | | |
| 3 | 4.38 ± 0.15^{a} | 4.40 ± 0.10^{a} | — |
| 7 | 5.38 ± 0.34^{a} | 4.51 ± 0.18^{b} | 0.87* |
| 10 | 7.58 ± 0.08^{a} | 6.40 ± 0.16^{b} | 1.18* |
| | Psychrotrophic bacteria (log CFU/g) | | Reduction |
| | | PP/ | psychrotrophic |
| | PP/PP:10% EVA | PP:10% EVA:20% PS_SB | bacteria |
| Day | tray | tray | (log CFU/g) |
| 0 | 3.49 ± 0.34 | | |
| 3 | 3.85 ± 0.13^{a} | 3.54 ± 0.05^{b} | 0.31 |
| 7 | 5.59 ± 0.35^{a} | 4.41 ± 0.20^{b} | 1.17* |
| 10 | 7.63 ± 0.13^{a} | 6.37 ± 0.20^{b} | 1.25* |

Values among same day of analysis within the same row and with a different superscript letter are significantly different at p ≤ 0.05 (LSD analysis)
DL = 1.6 log CFU/g
*Significant log reduction
(—) no reduction

TABLE 16
Enumeration of microbial population and log reduction of peeled cut
orange packed with control and active trays stored at 4° C. for
7 days followed by 3 days at 8° C.

| | Orange | | |
|---|---|---|---|
| | Total aerobic counts (log CFU/g) | | Log |
| | | PP/ | reduction total |
| | PP/PP:10% EVA | PP:10% EVA:20% PS_SB | aerobic counts |
| Day | tray | tray | (log CFU/g) |
| 0 | 3.59 ± 0.12 | | |
| 3 | 3.74 ± 0.28^{a} | 3.73 ± 0.45^{a} | 0.01 |
| 7 | 3.76 ± 0.14^{a} | 3.58 ± 0.19^{a} | 0.18 |
| 10 | 5.78 ± 0.08^{a} | 5.78 ± 0.20^{a} | — |
| | Molds and yeasts (log CFU/g) | | Log reduction |
| | | PP/ | molds |
| | PP/PP:10% EVA | PP:10% EVA:20% PS_SB | and yeasts |
| Day | tray | tray | (log CFU/g) |
| 0 | 2.93 ± 0.09 | | |
| 3 | 3.29 ± 0.15^{a} | 3.35 ± 0.13^{a} | — |
| 7 | 4.51 ± 0.16^{a} | 4.72 ± 0.29^{a} | — |
| 10 | 6.69 ± 0.06^{a} | 6.63 ± 0.10^{a} | 0.06 |
| | Psychrotrophic bacteria (log CFU/g) | | Log reduction |
| | | PP/ | psychrotrophic |
| | PP/PP:10% EVA | PP:10% EVA:20% PS_SB | bacteria |
| Day | tray | tray | (log CFU/g) |
| 0 | 3.77 ± 0.10 | | |
| 3 | 3.79 ± 0.21^{a} | 3.77 ± 0.19^{a} | 0.02 |
| 7 | 4.74 ± 0.16^{a} | 4.84 ± 0.30^{a} | — |
| 10 | 6.94 ± 0.11^{a} | 6.73 ± 0.16^{a} | 0.21 |

(*) Significant log reduction
(—) no reduction
Values among same day of analysis within the same row and with a different superscript letter are significantly different at p ≤ 0.05 (LSD analysis)
DL = 1.6 log CFU/g

In general, the microbial loads for pineapple packed with the active tray were lower than for the control trays. By day 10, the total microbial load reduction was around 0.5 log CFU/g for mesophilic bacteria, almost 1 log for mould and yeast and more than 1 log CFU/g for psychrophilic bacteria. On the other hand, no antimicrobial effect was observed for orange packed with active trays.

Although active tray did not prove to be very effective against microbial deterioration in orange, the active tray was tested together with the active lid in order to evaluated possible synergistic effects between the volatile compounds released from the active lid and the solid compounds incorporated in the active tray.

From the validation of the active tray it is concluded that the material developed was effective in terms of antimicrobial properties for pineapple where the maximum antimicrobial effect was observed at the end of storage period by day 10. No antimicrobial effect was observed for orange packed with active trays.

Sensory Evaluation of the Fruit

A sensory evaluation test was carried out by 10 consumers panel who scored the visual quality (color and general appearance) and also the odor perception of peeled and cut orange and pineapple packed with packed with control (PP/PP:10% EVA) and active tray (PP/PP:10% EVA:20% PS_SB) stored at 4° C. for 7 days followed by 3 days at 8° C. was carried out. Ratings were based on a 5-point hedonic scale where 5 was very good, 4 was good, 3 was fair (limit of marketability), 2 was poor and 1 was bad (unusable).

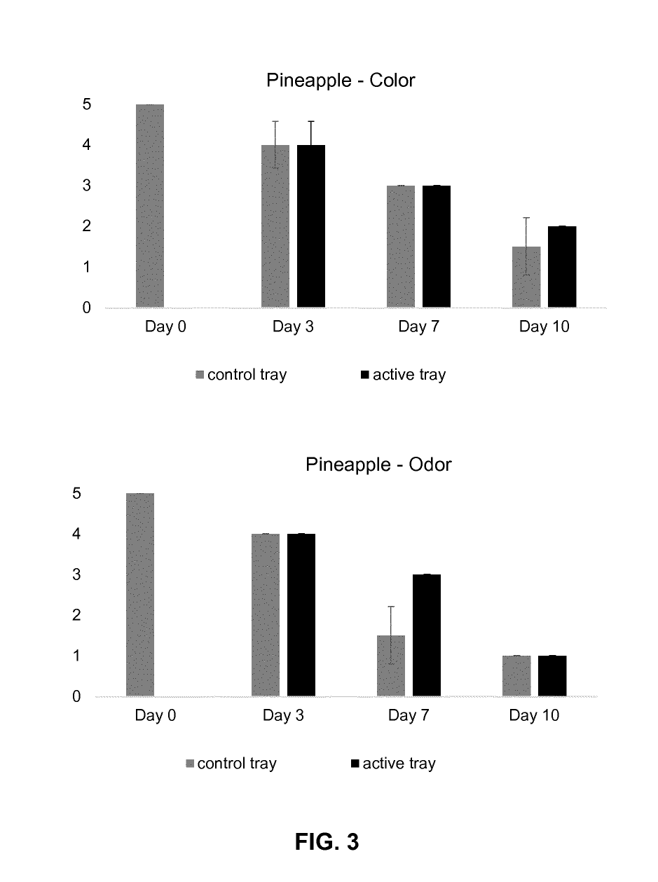

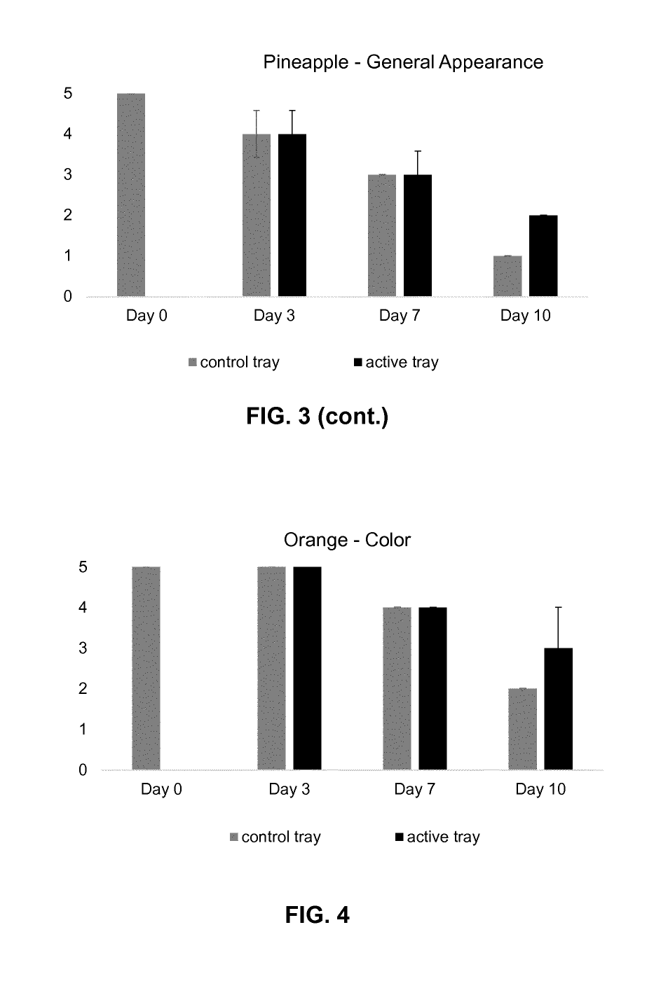

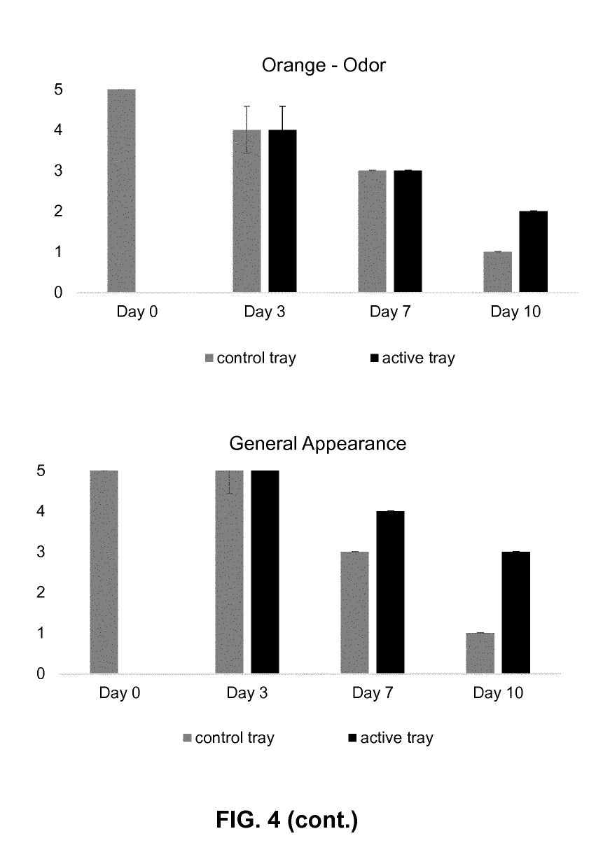

FIG. 3 and FIG. 4 shows the sensory parameters color, odor and general appearance evaluated for pineapple and orange, respectively along the storage period, respectively.

The sensory attributes of fruit gradually decreased along the storage period regardless of the packaging material. However, fruit packed with active packaging trays was generally slightly higher scored compared to control packaging.

### Example 17.—In Vivo Assays of the Active Packaging System (Active Tray+Active Lid) in Peeled and Cut Orange and Pineapple

Combination of active tray and lid were validated in fresh cut pineapple and orange. Physiochemical properties (°Brix, pH, juice leakage, sensory evaluation), microbial counts of orange and pineapple packed with antimicrobial and control active system were evaluated.

Peeled and cut orange or pineapple was packaged with active films in combination with active trays (PP10/70a_8.5% CHL film and PP/PP:10% EVA:20% PS_SB tray). Films were perforated with 2 holes of 250 μm to allow the gas exchange with the environment and avoid anaerobic conditions. Fruit was packed under air conditions and stored at 4° C. for 7 days followed by 5 days at 8° C. in order to simulate abuse temperatures that can occur along the supply chain. Orange and pineapple were also packed with PP films and PP trays as a control packaging system.

Antimicrobial Properties of the Active Packaging Solution

The peeled cut fruit was subjected to microbiological analyses along the storage period at 4/8° C. The microflora of the fruit packed with active and control trays was evaluated by day 0, 3, 5, 7, 10 and 12 in terms of total aerobic count, molds and yeast and psychrotrophic bacteria. Day 0 was defined as microbial load before the packaging process.

Table 17 and Table 18 shows the microbial quality of orange and pineapple packed with control and active system stored for 12 days at 4/8° C. As it can be observed, the microbial load remained quite stable along the shelf life (mesophilic bacteria, mould and yeast a psychrophilic bacteria) for pineapple when packed with the active packaging system between 1 and 3 logs below the pineapple packed with control packaging.

A value of 6 log 10 cfu/g for aerobic bacteria was taken as a reference for the limit for microbial populations on minimally fresh processed fruit for safe consumption. The results showed that the active packaging kept pineapple microbial loads below or equal to 6 log 10 cfu/g along the studied period (12 days), being a safe product for human consumption up to 12 days. Regarding oranges packed with active packaging, this product is safe for consumer in terms of mesophilic bacteria up to almost day 10. However, moulds and yeast and phycrophilic bacteria are slightly higher than for pineapple overcoming the safe limit after 10 days of storage but always lower than the samples control.

Compared to the antimicrobial effect of the active lid and the active tray, a synergetic effect was observed from the combination of both active film and tray.

TABLE 17
Enumeration of microbial population of peeled and cut pineapple
packed with control (PP80 film and PP/PP:10% EVA tray) and active
packaging system (PP10/70a_8.5% CHL film and PP/PP:10%
EVA:20% PS_SB tray) stored at 4° C. for 7 days
followed by 5 days at 8° C.

| | Pineapple | | |
|---|---|---|---|
| | Total aerobic counts (log CFU/g) | | |
| | | PP10/70a_8.5% | |
| | PP80 film + | CHL film + PP/PP:10% | Log reduction total |
| | PP/PP:10% EVA | EVA:20% PS_SB | aerobic counts |
| Day | tray | tray | (log CFU/g) |
| 0 | 4.84 ± 0.58 | | |
| 3 | 5.77 ± 0.71^{a} | 4.91 ± 0.52^{a} | 0.86 |
| 5 | 5.46 ± 0.20^{a} | 3.86 ± 0.24^{b} | 1.60* |
| 7 | 5.99 ± 0.21^{a} | 3.99 ± 0.13^{b} | 2.00* |
| 10 | 6.44 ± 0.14^{a} | 4.93 ± 0.45^{b} | 1.51* |
| 12 | 6.69 ± 0.41^{a} | 5.35 ± 0.64^{b} | 1.34* |
| | Molds and yeasts (log CFU/g) | | |
| | | PP10/70a_8.5% | |
| | PP80 film + | CHL film + PP/PP:10% | Log reduction molds |
| | PP/PP:10% EVA | EVA:20% PS_SB | and yeasts |
| Day | tray | tray | (log CFU/g) |
| 0 | 4.29 ± 0.12 | | |
| 3 | 6.01 ± 0.23^{a} | 4.28 ± 0.34^{b} | 1.74* |
| 5 | 6.55 ± 0.44^{a} | 5.01 ± 0.41^{b} | 1.54* |
| 7 | 8.06 ± 0.10^{a} | 5.21 ± 0.12^{b} | 2.85* |
| 10 | 8.34 ± 0.05^{a} | 6.03 ± 0.43^{b} | 2.30* |
| 12 | 8.53 ± 0.03^{a} | 5.85 ± 0.42^{b} | 2.67* |
| | Psychrotrophic bacteria (log CFU/g) | | |
| | | PP10/70a_8.5% | Log reduction |
| | PP80 film + | CHL film + PP/PP:10% | psychrotrophic |
| | PP/PP:10% EVA | EVA:20% PS_SB | bacteria |
| Day | tray | tray | (log CFU/g) |
| 0 | 2.76 ± 0.08 | | |
| 3 | 5.97 ± 0.20^{a} | 4.84 ± 0.35^{b} | 1.13* |
| 5 | 6.67 ± 0.53^{a} | 5.01 ± 0.47^{b} | 1.66* |
| 7 | 7.77 ± 0.01^{a} | 5.17 ± 0.14^{b} | 2.60* |
| 10 | 8.23 ± 0.03^{a} | 6.00 ± 0.44^{b} | 2.24* |
| 12 | 8.40 ± 0.16^{a} | 5.78 ± 0.54^{b} | 2.62* |

Values among same day of analysis within the same row and with a different superscript letter are significantly different at p ≤ 0.05 (Tukey analysis).
DL = 1.6 log CFU/g
*Significant log reduction

TABLE 18
Enumeration of microbial population of peeled and cut orange
(Navel) packed with control (PP80 film and PP/PP:10% EVA tray)
and active packaging system (PP10/70a_8.5% CHL film
and PP/PP:10% EVA:20% PS_SB tray) stored at 4° C. for
7 days followed by 5 days at 8° C.

| | Orange | | |
|---|---|---|---|
| | Total aerobic counts (log CFU/g) | | |
| | | PP10/70a_8.5% | |
| | PP80 film + | CHL film + PP/PP:10% | Log reduction total |
| | PP/PP:10% EVA | EVA:20% PS_SB | aerobic counts |
| Day | tray | tray | (log CFU/g) |
| 0 | 4.49 ± 0.75 | | |
| 3 | 4.75 ± 0.19^{a} | 4.28 ± 0.13^{b} | 0.47* |
| 5 | 4.74 ± 0.07^{a} | 3.71 ± 0.13^{b} | 1.03* |
| 7 | 5.66 ± 0.16^{a} | 4.05 ± 0.34^{b} | 1.61* |
| 10 | 6.91 ± 0.20^{a} | 6.31 ± 0.19^{b} | 0.60* |
| 12 | 6.93 ± 0.18^{a} | 6.58 ± 0.04^{b} | 0.36* |
| | Molds and yeasts (log CFU/g) | | |
| | | PP10/70a_8.5% | |
| | PP80 film + | CHL film + PP/PP:10% | Log reduction molds |
| | PP/PP:10% EVA | EVA:20% PS_SB | and yeasts |
| Day | tray | tray | (log CFU/g) |
| 0 | 3.45 ± 0.02 | | |
| 3 | 5.62 ± 0.16^{a} | 4.73 ± 0.16^{b} | 0.89* |
| 5 | 6.07 ± 0.15^{a} | 5.09 ± 0.30^{b} | 0.97* |
| 7 | 7.16 ± 0.22^{a} | 5.67 ± 0.20^{b} | 1.49* |
| 10 | 8.33 ± 0.07^{a} | 7.70 ± 0.23^{b} | 0.63* |
| 12 | 8.46 ± 0.03^{a} | 8.00 ± 0.03^{b} | 0.47* |
| | Psychrotrophic bacteria (log CFU/g) | | |
| | | PP10/70a_8.5% | Log reduction |
| | PP80 film + | CHL film + PP/PP:10% | psychrotrophic |
| | PP/PP:10% EVA | EVA:20% PS_SB | bacteria |
| Day | tray | tray | (log CFU/g) |
| 0 | 2.73 ± 0.23 | | |
| 3 | 5.72 ± 0.14^{a} | 4.52 ± 0.31^{b} | 1.19* |
| 5 | 6.29 ± 0.21^{a} | 5.92 ± 0.44^{b} | 0.37* |
| 7 | 7.14 ± 0.15^{a} | 5.83 ± 0.18^{b} | 1.30* |
| 10 | 8.40 ± 0.03^{a} | 7.55 ± 0.12^{b} | 0.84* |
| 12 | 8.52 ± 0.06^{a} | 8.05 ± 0.06^{b} | 0.48* |

Values among same day of analysis within the same row and with a different superscript letter are significantly different at p ≤ 0.05 (Tukey analysis)
DL = 1.6 log CFU/g
*Significant log reduction

On one hand, the active lid containing volatile compounds already shown higher effectiveness in pineapple and orange along the storage period of the fruit. However, low antimicrobial effect was observed for the active trays in the tested fruit.

From the combination of the active lid and the active tray, it is concluded that the active system developed was more effective in terms of antimicrobial properties in pineapple and orange than the active materials individually, keeping the microbiological quality under safe levels up to 12 days of storage for pineapple and 7 days for orange. The fruit packed with control packaging materials overcame the quality limits of 6 log CFU/g at day 5 for pineapple and orange.

Sensory Evaluation

A sensory evaluation test was carried out by 10 consumers panel who scored the visual quality (color and general appearance) and also the odor perception of peeled and cut orange and pineapple packed with control (PP80 film+PP/PP:10% EVA tray) and active packaging system (PP10/70a_8.5% CHL film+PP/PP:10% EVA:20% PS_SB tray) stored at 4° C. for 7 days followed by 3 days at 8° C. Ratings were based on a 5-point hedonic scale where 5 was very good, 4 was good, 3 was fair (limit of marketability), 2 was poor and 1 was bad (unusable).

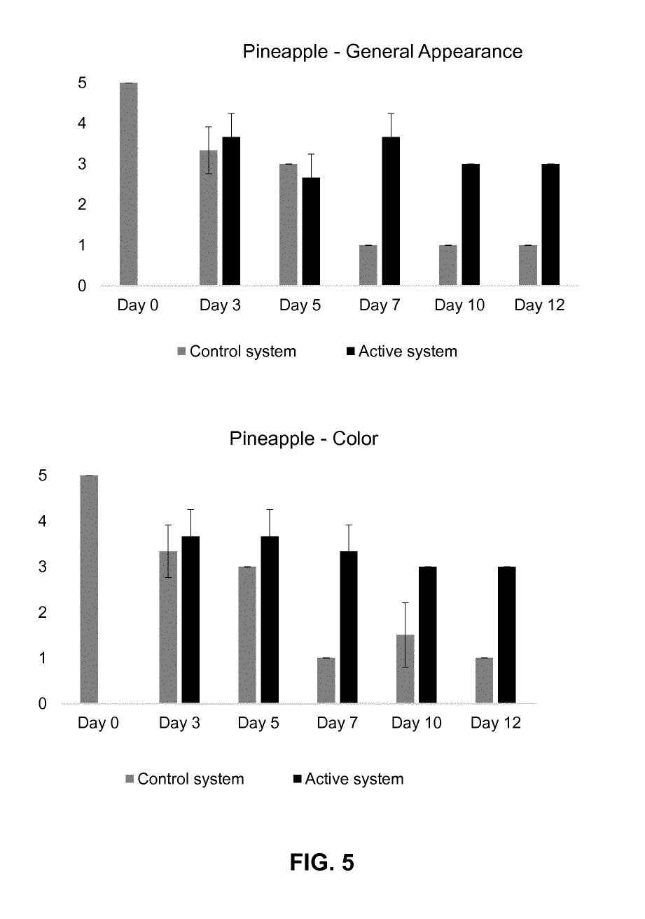

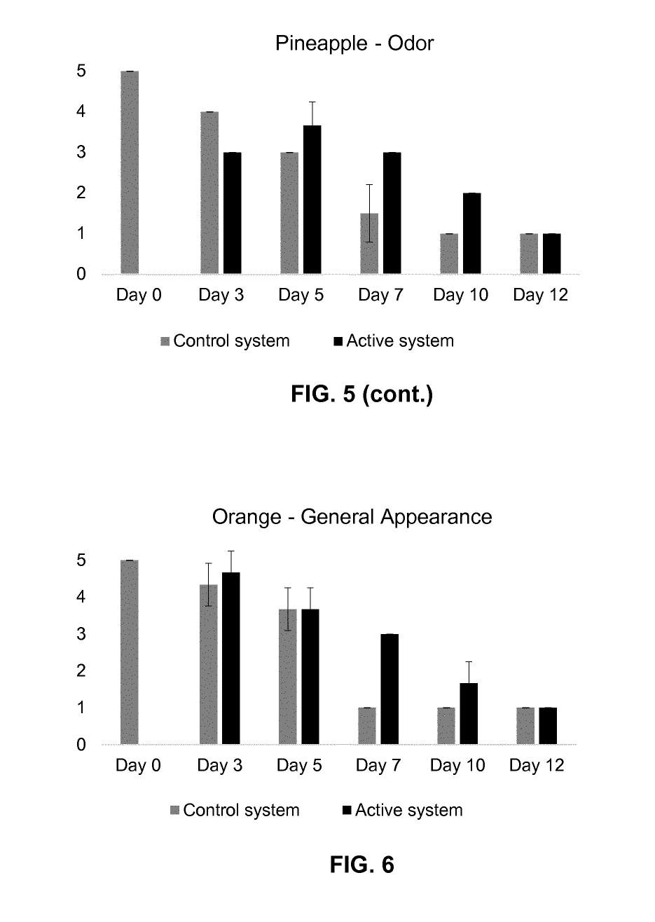

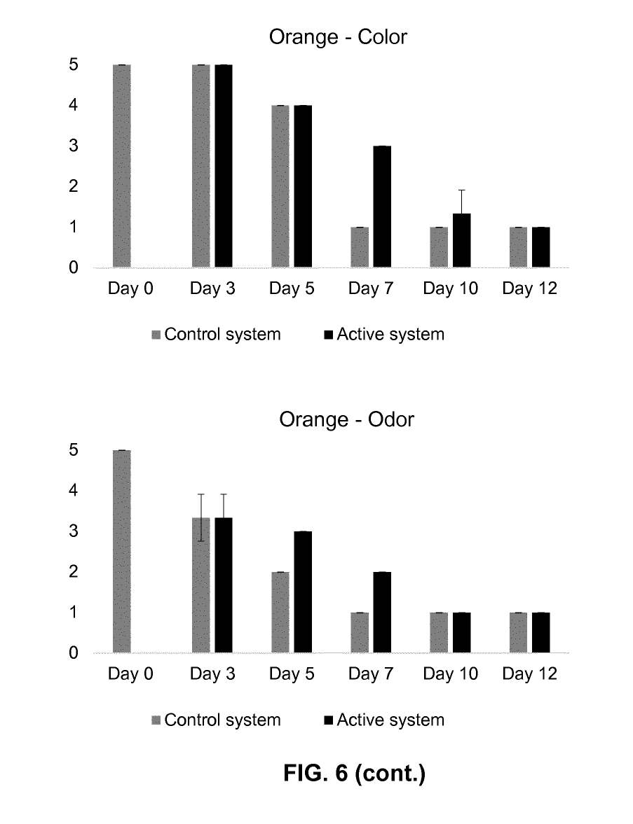

FIG. 5 and FIG. 6 show the sensory parameters color, odor and general appearance evaluated for pineapple and orange packed with the active packaging system along the storage period, respectively.

The sensory attributes of fruit gradually decreased along the storage period regardless of the packaging material. However, fruit packed with active packaging system was significantly higher scored compared to control packaging system.

### REFERENCES CITED IN THE APPLICATION

1. Soliva-Fortuny, et al. “New advances in extending the shelf-life of fresh-cut fruits: a review” Trends in Food Science & Technology, 2003, Vol. 14, pp. 341-353.
2. V. Muriel-Galet et al., “Development of antimicrobial films for microbiological control of packaged salad”, International Journal of Food Microbiology, 2012; Vol. 157. pp. 195-201.
3. Lanciotti et al. “Effect of Hexanal on the Shelf Life of Fresh Apple Slices”, J. Agric. Food Chem. 1999, Vol. 47, pp. 4769-4776.
4. P. Suppakul et al. “Efficacy of polyethylene-based antimicrobial films containing principal constituents of basil”, LWT—Food Science and Technology, 2008, Vol. 41, pp. 779-788.

For reasons of completeness, various aspects of the invention are set out in the following numbered clauses:

1. An antimicrobial combination of citral, hexanal, and linalool for the preservation of foodstuff.

2. The antimicrobial combination according to clause 1, wherein the amount of each one of citral, hexanal and linalool is from 1 to 90 wt. %, particularly from 15 to 75 wt. %, more particularly from 25 to 60 wt. %, with respect to the total amount of citral, hexanal, and linalool.

3. The antimicrobial combination according to clause 2, wherein the amount of citral is 33.3 wt %, the amount of hexanal is 33.3 wt. % and the amount of linalool is 33.3 wt. %, with respect to the total amount of the three active agents.

4. An active formulation for foodstuff packaging comprising a polymeric matrix and the antimicrobial combination as defined in any one of clauses 1 to 3.

5. The active formulation according to clause 4, which is either
a) to be processed by injection or extrusion techniques, wherein the amount of the antimicrobial combination of citral, hexanal, and linalool as defined in any one of clauses 1 to 3 is from 0.5 to 10 wt. %, or from 2 to 8.5 wt. %, or from 3 to 6 wt. %, with respect to the total amount of citral, hexanal, linalool, and polymeric matrix; or alternatively,
b) to be used as a coating, wherein the amount of the antimicrobial combination of citral, hexanal, and linalool as defined in any one of clauses 1 to 3 is from is from 10 to 40 wt. %, particularly from 15 to 30 wt. %, with respect to the polymeric matrix.

6. An active packaging material for the preservation of foodstuff, comprising the active formulation as defined in clauses 4 or 5.

7. The active packaging material according to clause 6, wherein the active formulation is forming a layer, and further comprising a structural layer.

8. The active packaging material according to clause 7, which is a lid, a tray, a film, a paper, a bag, a label, or a pad.

9. A process for the preparation of the packaging material as defined in any one of clauses 6 to 8, wherein the process comprises:
i) melt mixing a polymeric matrix and the active agents citral, hexanal, and linalool to obtain the active formulation as defined in any one of clauses 4 to 7; and
ii) processing the active formulation obtained in step i) through either extrusion or injection to provide a single or multilayer structure, in order to obtain a packaging material comprising a polymeric matrix and citral, hexanal, and linalool.

10. The process according to clause 9 wherein step ii) is carried out by submitting the active formulation to coextrusion or coinjection with at least one polymer, which can be the same as or different to the polymer in the active formulation, in order to obtain a structure of at least two layers comprising a structural layer and a layer of the active formulation as defined in clauses 4 or 5.

11. A process for preparing the packaging material as defined in any one of clauses 6 to 8, comprising the steps of:
a) optionally, applying to the surface of a substrate to be coated with the active formulation a corona treatment;
b) preparing an active formulation in the form of a solution by dissolving a polymeric matrix in at least one suitable solvent; optionally, incorporating at least one plasticiser; optionally, incorporating at least one anti-fog compound; and incorporating the antimicrobial combination of the invention;
c) applying the active formulation of the invention to the substrate by coating, printing, dipping, or spraying; and
d) drying the layer comprising the active formulation.

12. Use of the packaging material as defined in clauses 6 to 8 for the preservation of foodstuff, particularly of minimally processed fruits and vegetables, more particularly of fresh peeled and/or cut fruits or vegetables.

13. An active package comprising the packaging material defined in any one of clauses 6 to 8.

14. The active package according to clause 13, comprising (1) a packaging material as defined in clause 10 which is a lid, and (2) a tray comprising a coating layer comprising potassium sorbate and sodium benzoate.

15. The active package according to clauses 13 or 14, wherein the foodstuff is minimally processed fruits and vegetables, more particularly fresh peeled and/or cut fruits or vegetables.

1. An antimicrobial combination for the preservation of foodstuff, comprising citral, hexanal, and linalool as the only active ingredients having antimicrobial activity, and optionally other components and/or excipients devoid of any antimicrobial activity.

2. The antimicrobial combination according to claim 1, wherein the amount of each one of citral, hexanal and linalool is from 1 to 90 wt. %, particularly from 15 to 75 wt. %, more particularly from 25 to 60 wt. %, with respect to the total amount of citral, hexanal, and linalool.

3. The antimicrobial combination according to claim 1 consisting of citral, hexanal, and linalool.

4. The antimicrobial combination according to claim 3, wherein the amount of citral is 33.3 wt %, the amount of hexanal is 33.3 wt. % and the amount of linalool is 33.3 wt. %, with respect to the total amount of the three active agents.

5. An active formulation for foodstuff packaging comprising a polymeric matrix and a safe and effective amount of the antimicrobial combination as defined in claim 1.

6. The active formulation according to claim 5, which is either
a) to be processed by injection or extrusion techniques, wherein the amount of the antimicrobial combination of citral, hexanal, and linalool as defined in any one of claims 1 to 4 is from 0.5 to 10 wt. %, or from 2 to 8.5 wt. %, or from 3 to 6 wt. %, with respect to the total amount of citral, hexanal, linalool, and polymeric matrix; or alternatively,
b) to be used as a coating, wherein the amount of the antimicrobial combination of citral, hexanal, and linalool is from 10 to 40 wt. %, particularly from 15 to 30 wt. %, with respect to the polymeric matrix.

7. An active packaging material for the preservation of foodstuff, comprising the active formulation as defined in claim 5.

8. The active packaging material according to claim 7, which is a lid, a tray, a film, a paper, a bag, a label, or a pad, wherein the active formulation is forming a layer, and further comprising a structural layer.

9. A process for the preparation of the packaging material as defined in claim 7, wherein the process comprises:
i) melt mixing a polymeric matrix and the active agents citral, hexanal, and linalool to obtain the active formulation; and
ii) processing the active formulation obtained in step i) through either extrusion or injection to provide a single or multilayer structure, in order to obtain a packaging material comprising a polymeric matrix and citral, hexanal, and linalool.

10. The process according to claim 9 wherein step ii) is carried out by submitting the active formulation to coextrusion or coinjection with at least one polymer, which can be the same as or different to the polymer in the active formulation, in order to obtain a structure of at least two layers comprising a structural layer and a layer of the active formulation.

11. A process for preparing the packaging material as defined in claim 7, comprising the steps of:
a) optionally, applying to the surface of a substrate to be coated with the active formulation a corona treatment;
b) preparing an active formulation in the form of a solution by dissolving a polymeric matrix in at least one suitable solvent; optionally, incorporating at least one plasticiser; optionally, incorporating at least one anti-fog compound; and incorporating the antimicrobial combination of the invention;
c) applying the active formulation of the invention to the substrate by coating, printing, dipping, or spraying; and
d) drying the layer comprising the active formulation.

12. Use of the packaging material as defined in claim 7 for the preservation of foodstuff, particularly of minimally processed fruits and vegetables, more particularly of fresh peeled and/or cut fruits or vegetables.

13. An active package comprising the packaging material defined in claim 7.

14. The active package according to claim 13, comprising a packaging material which is a lid, and a tray comprising a coating layer comprising potassium sorbate and sodium benzoate.

15. The active package according to claim 13, wherein the foodstuff is minimally processed fruits and vegetables, more particularly fresh peeled and/or cut fruits or vegetables.
